(19) United States
(12) Patent Application Publication
(10) Pub. No.: US 2018/0191677 A1
(43) Pub. Date: Jul. 5, 2018

(54) FIREWALL AND METHOD THEREOF

(71) Applicant: IoT Defense, Inc., Merrifield, VA (US)

(72) Inventors: Tilakraj ROYCHOUDHURY, Falls Church, VA (US); Stuart A. CARROLL, Oak Hill, VA (US)

(21) Appl. No.: 15/858,488

(22) Filed: Dec. 29, 2017

Related U.S. Application Data
(60) Provisional application No. 62/441,092, filed on Dec. 30, 2016.
(60) Provisional application No. 62/441,110, filed on Dec. 30, 2016.
(60) Provisional application No. 62/441,117, filed on Dec. 30, 2016.
(60) Provisional application No. 62/441,121, filed on Dec. 30, 2016.
(60) Provisional application No. 62/441,126, filed on Dec. 30, 2016.

(51) Int. Cl. H04L 29/06; H04L 29/12

(52) U.S. Cl. CPC H04L 63/0227; H04L 61/6022; H04L 63/0281; H04L 61/6068

(57) ABSTRACT

A firewall for selectively allowing or blocking traffic between a first network interface and a second network interface. A packet classifier evaluates the traffic between the first network interface and the second network interface and allows or blocks the traffic based on content of classifier data accessible by the packet classifier. An IP address identifier identifies an IP address of the second network interface. A classifier data updater initiates a request for the classifier data to be updated, and receives an update to the classifier data responsive thereto, wherein the request is transmitted from the updater to the first network interface, the update is received from the first network interface, and the request identifies the firewall as destination of the update with the IP address of the second network interface identified by the IP address identifier.

This application claims the benefit of the following patent applications under 35 U.S.C. § 119(e): 1) RECEPTION AND TRANSMISSION OF NETWORK TRAFFIC BY A NON-ADDRESSABLE NETWORK DEVICE, application Ser. No. 62/441,117, Filed: Dec. 30, 2016; 2) NETWORK BRIDGE DEVICE TRAFFIC ANALYSIS, BLOCKING AND NOTIFICATION, application Ser. No. 62/441,092, Filed: Dec. 30, 2016; 3) NETWORK BRIDGE DEVICE INTERFACE AUTO-CONFIGURATION, application Ser. No. 62/441,110, Filed: Dec. 30, 2016; 4) NETWORK BRIDGE DEVICE SECURE SERVICE PROXY, application Ser. No. 62/441,121, Filed: Dec. 30, 2016; and 5) IP ADDRESS CLASSIFICATION AND SCORING THROUGH DATA COALESCING, DE-DUPLICATION, AND TRUNCATION, application Ser. No. 62/441,126, Filed: Dec. 30, 2016; all of which are hereby incorporated by reference in their entireties.

### FIELD OF THE INVENTION

The present invention relates to networks, and in particular to network devices. More specifically, a network device, such as a firewall, is disclosed that communicates with other network devices.

### BACKGROUND OF THE INVENTION

Network communication is an extremely important technology that provides essential services, significant value, and potential problems. Over time, networks have become more robust and more complex, leading to the motivation to provide network devices with improved features.

One significant network feature is security. It is important for networks to operate with safety and without malicious interference.

Another significant network feature is communication. With the increasing complexity of networks, reliable and efficient communication is vitally important.

An unprotected computer system can be exploited and harmed by software such as viruses, worms, and other invasive and harmful computer programs. Hardware and software devices continue to be designed in order to prevent security breaches to network systems.

One apparatus (hardware, software, or both) to protect resources of a private network is what is called a firewall. When a network accesses the Internet, a firewall is desirable to prevent outsiders from accessing the network's private data resources. A firewall examines data traffic to determine whether it is safe for the traffic to be forwarded to its intended destination. Data packets addressed to a network (LAN) are examined by a firewall. The firewall includes software that tries to determine whether data packets are potentially malicious. Packets that have been identified as being potentially malicious are prevented from reaching the LAN.

The vulnerability of networks is expected to increase with the introduction of the Internet of things (IOT). IOT devices connect to a network for performing specific roles. Examples of IOT devices include refrigerators, dish washers, clothes washers, clothes dryers, thermostats, digital video recorders, gaming consoles, smart TVs, media players, smart baby monitors, smart door locks, smart voice assistants etc. These appliances may be able to communicate with each other or with a smart phone by which they can be controlled.

Such IOT devices, however, are vulnerable to attack. Infection of such devices for enrolling them in a botnet and delivering a subsequent denial of service (DOS) attack is conceivable. While antivirus software is often installed on a computer to prevent malicious attack, IOT devices are not capable of running such software due to resource constraints.

### SUMMARY OF THE INVENTION

A firewall for selectively allowing or blocking traffic between a first network interface and a second network interface. A packet classifier evaluates the traffic between the first network interface and the second network interface and allows or blocks the traffic based on content of classifier data accessible by the packet classifier. An IP address identifier identifies an IP address of the second network interface. A classifier data updater initiates a request for the classifier data to be updated, and receives an update to the classifier data responsive thereto, wherein the request is transmitted from the updater to the first network interface, the update is received from the first network interface, and the request identifies the firewall as destination of the update with the IP address of the second network interface identified by the IP address identifier.

### BRIEF DESCRIPTION OF THE DRAWINGS

FIG. 1 is a block diagram that illustrates a network interface device within a network in accordance with a 1^{st} exemplary embodiment of the present invention.

FIG. 2 is a block diagram that illustrates a network interface device within a network in accordance with a 2^{nd} exemplary embodiment of the present invention.

FIG. 3 is a block diagram that illustrates an apparatus for obtaining and updating threat detection data in accordance with an exemplary embodiment of the present invention.

FIGS. 4a and 4b are flowchart diagrams that illustrate update of firewall data in accordance with an exemplary embodiment of the present invention.

FIG. 5A and FIG. 5B are more detailed diagrams that illustrate aspects of exemplary embodiments of the present invention that are illustrated in FIG. 1 and FIG. 2, respectively.

FIG. 6 is a block diagram that illustrates an exemplary embodiment of the present invention that allows for the dynamic configuration of network device interfaces.

FIG. 7 is a flowchart diagram that illustrates an exemplary process for configuring network device interfaces within a network device.

FIG. 8 is a flowchart diagram that illustrates auto configuration of ports on a network device in accordance with an exemplary embodiment of the present invention.

FIG. 9 is a flowchart diagram that illustrates further exemplary steps for dynamically configuring a network interface in accordance with an exemplary embodiment of the present invention.

FIG. 10 is a block diagram that illustrates flow of requests from a home internet router through a network device to a server on the internet.

FIG. 11 is a block diagram that illustrates flow of requests and responses between the home internet router and a secure server through the network device when secure service proxy feature is engaged.

FIG. 12 is a flow chart diagram that illustrates the aggregation of threat intelligence data from multiple fees in accordance with a further exemplary embodiment of the present invention.

### DETAILED DESCRIPTION

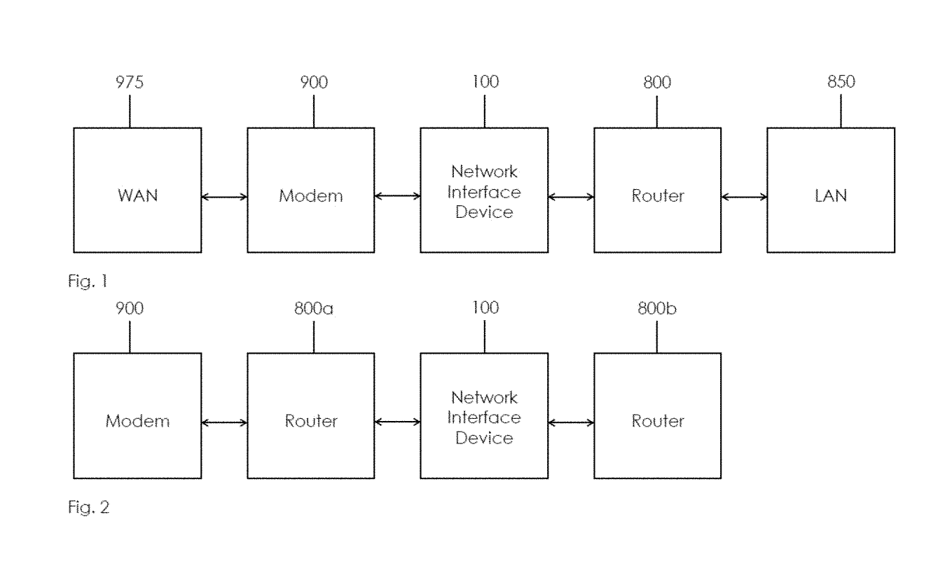

FIG. 1 is a block diagram that illustrates one exemplary configuration of a network interface device. As shown, network interface device 100 is coupled between modem 900 and router 800. Modem 900 communicates with a wide area network (WAN) such as the Internet. Router 800 communicates with a local area network (LAN) such as a home network. In one exemplary embodiment of the present invention, network interface device 100 is firewall 101. A firewall is being described for illustrative purposes, although it is understood that network interface device 100 can have a variety of different functions that are not necessarily the same as what is performed by a firewall. Other types of functions such as data acquisition, for example, are contemplated. In the example being described, firewall 101 serves the purpose of trying to identify and remove malicious traffic that is flowing between modem 900 and router 800. As will be described in more detail below, one exemplary method of operation of firewall 101 is to evaluate IP addresses associated with packets flowing through firewall 101. Under certain circumstances that are illustrated below, packets may be permitted or prevented from flowing between modem 900 and router 800 depending upon the content of address fields (for example) that are evaluated flowing therein.

While FIG. 1 illustrates network interface device 101 functioning between a modem and a router, network interface device 100 functions as a bridge, i.e. between two routers. Such a configuration is shown in FIG. 2. As shown in FIG. 2, network interface device 100 is coupled between router 800 A and router 800 B. Router 800 A is further shown connected to modem 900. In this configuration as well, network interface device 100 may include firewall 101. The configurations shown in FIG. 1 and FIG. 2 are merely exemplary, as other configuration may be contemplated. A further example would be a configuration in which network interface device 100 is physically located between a router and an endpoint.

Generally speaking, one aspect of the invention relates to a networking device that bridges (forwards) network packets between two network interfaces. Another aspect of the invention relates to a bridge device that can examine the network layer (IP addresses in network packets and make decisions to forward or block the packets between the aforementioned network interfaces. Another aspect of the invention relates to one network device that can “borrow” the public IP address of another network device in order to transmit requests to a network (such as the internet) and can receive a response to that request. Yet another aspect of the invention relates to one network device that can “borrow” the private IP address of another network device in order to transmit requests to a network (such as the internet) and can receive a response to that request. That aspect of the invention may relate to an embodiment in which the network device that “borrows” the private IP address is behind a router. The invention also relates to a device that periodically downloads network layer (IP) address information from internet based attack threat intelligence data sources and feeding the information into a network layer classifier to allow or block traffic flowing between multiple network interfaces on a bridging device. In addition, one aspect of the invention relates to network layer and transport layer metadata, from packets blocked by the aforementioned process, being sent to an internet based server in real time to perform analytics and visualization.

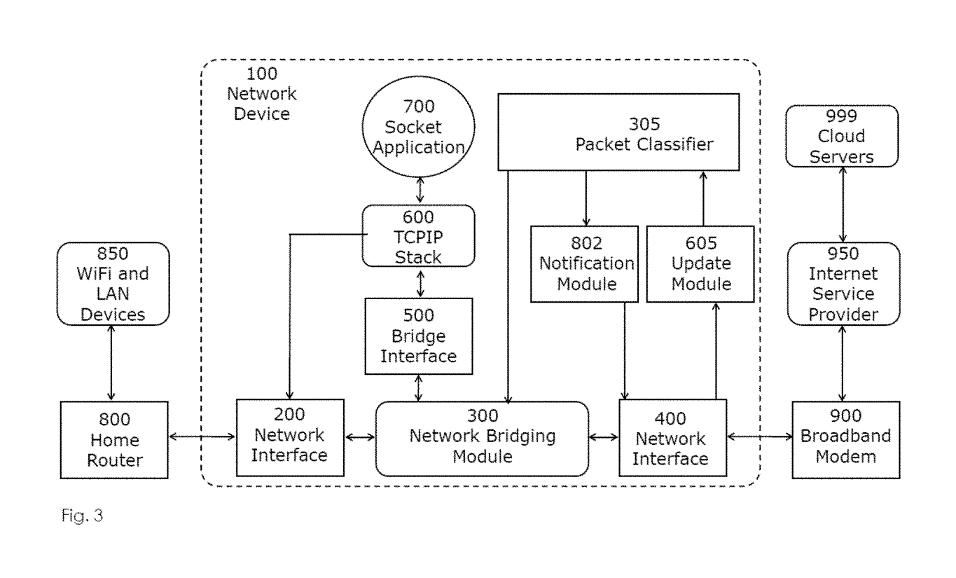

FIG. 3 is a block diagram that illustrates flow of packets between interfaces of a bridge device, the components used to download packet classification information from an internet based data feed, and components used to upload packet classification results to an internet based analytics service. More specifically, network device 100 is coupled to Internet service provider 950 and LAN devices 850 in accordance with an exemplary embodiment of the present invention.

As shown, network device 100 is coupled to Internet service provider 950 via a broadband modem 900. Furthermore, network device 100 is coupled to LAN devices 850 via router 800. Router 800 includes a single WAN interface and multiple LAN interfaces. The WAN interface is where router 800 and network device 100 connect. Connection between router 800 and network device 100 may be accomplished, for example, by using an Ethernet cable. Multiple devices such as computers, printers, scanners, etc., are connected to the LAN interfaces of router 800 in order to create a private network. Such a network may also include devices connected over Wi-Fi. Modem 900 also has network interfaces. One network interface is connected to network device 100. The connection between modem 900 and network device 100 may also be via an Ethernet cable.

In an exemplary embodiment of the present invention, network device 100 is operating at data link layer (layer-2) of the network stack, performing classification of packets using network and transport layer metadata present in packets flowing through the device. Network device 100 bridges packets between two network interfaces 200, 400. Network bridging occurs using packet metadata that is in the data link layer (Ethernet) header of network packets.

Network packets flow from one network interface 200 to another network interface 400 (and vice versa). A packet classifier 305 that examines the network layer metadata (source and destination IP addresses) and transport layer metadata (TCP and UDP port numbers) and makes a decision to allow the packet to flow through or to block the packet.

An update module 605 periodically downloads information from an threat intelligence feed server (not shown) and programs the information in packet classifier 305 to enable it to make classification decisions on packets flowing through network device 100. Upon blocking a packet, the packet classifier 305 sends metadata information about the dropped packet to the notification module 800 that instantaneously transmits the metadata to an analytics service (not shown) over the internet.

Packet classifier 305 is thus able to block packets that are determined to be malicious from being bridged (forwarded) from one interface 200 to another interface 400 (and vice versa), thus securing devices that are connected to the network interfaces 200, 400.

Exemplary embodiments of the invention can be implemented either on a standalone network device or as a part of the functionality of a multi-function device such as a router, modem, or wireless access point. Typically these embodiments are implemented as part of the routing functionality of a multi-function device such as a router, but this is merely exemplary.

An exemplary network device 100 is thus able to prevent malicious traffic from entering a user's home network and prevent malicious traffic originating from a potentially compromised home network from reaching its intended destination, i.e. attacker owned command and control servers on the internet. The user may also be informed of such attempted attacks in real time.

As previously explained, network device 100 includes network interface 200 for receiving data from and transmitting data to router 800. Physical connection between network interface 200 and router 800 may be via an Ethernet port that is accessible from the exterior of the enclosure in which network device 100 is situated. Network interface 400 is connected to modem 900 via a physical Ethernet port (for example) that is also accessible from the exterior of the enclosure in which network device 100 is situated.

Network interface 200 and network interface 400 are each comprised of a network interface module, for example, for exchanging data with router 800 and modem 900 respectively. Interface 200 and interface 400 may be configured for transmission and reception. In one exemplary embodiment of the present invention, interface 200 and/or interface 400 are programmable so that interface 200 may directly communicate with modem 900 and interface 400 may directly communicate with router 800. The process of programming interface 200 and interface 400 for transmission and reception of data is explained below.

Network device 100 bridges packets arriving from router 800, to modem 900, and vice a versa. Internet service provider 950 may assign a network layer Internet protocol (IP) address to router 800 via modem 900. The process of assigning an IP address to router 800 is known to one of ordinary skill in the art of Internet service provider IP assignments. However, for the average consumer, the process of an Internet service provider assigning an IP address to router 800 is performed automatically with no intervention from the consumer (beyond the consumer properly connecting, interconnecting, powering the modem and the router, and configuring the router for DHCP on the WAN interface).

Network interface 200 communicates with router 800 via a set of networking protocols. Those protocols are included in TCP/IP stack 600. TCP/IP stack 600, in turn, is consumed by socket application 700. Socket application 700 includes network application programming interface (API) for communicating with the internet.

As is well known in the art, router 800 has a public IP address that is assigned to it via Internet service provider 950. Router 800 also includes a private IP address that is known to LAN devices 850. Router 800 also has multiple MAC addresses, one for the WAN interface, and one for each LAN interface (since there may be multiple LAN interfaces).

In an exemplary embodiment of the present invention, a data request originates from LAN devices 850 and travels through router 800. Upon leaving router 800, that data request may go to a variety of different destinations. In accordance with FIG. 3, the data request that originates from LAN devices 850 may travel to the Internet via modem 900 and Internet service provider 950, but this is merely exemplary. When a data request travels from router 800 to the Internet, the request is sent as a packet that includes a header and a payload. The header includes the source IP address, the destination IP address, the source MAC address, and the destination MAC address. In a typical home network, for example, with regard to a request for data from router 800 to the Internet, the source MAC address is the WAN interface of router 800 and destination MAC address is Internet Service Provider 950 (since modem 900 is a bridge device), the source IP address is the public IP address of the WAN interface of router 800 and the destination IP address is the address of the server on the Internet to which the data request is targeted.

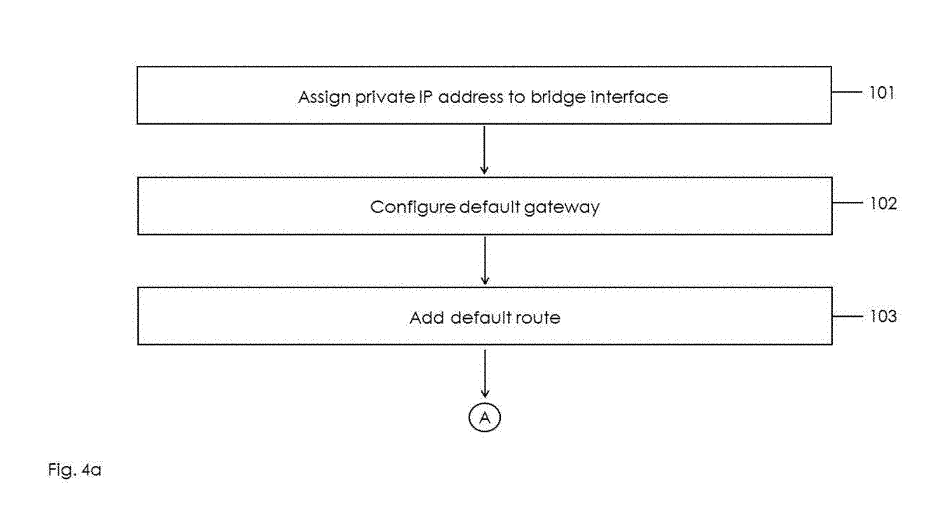

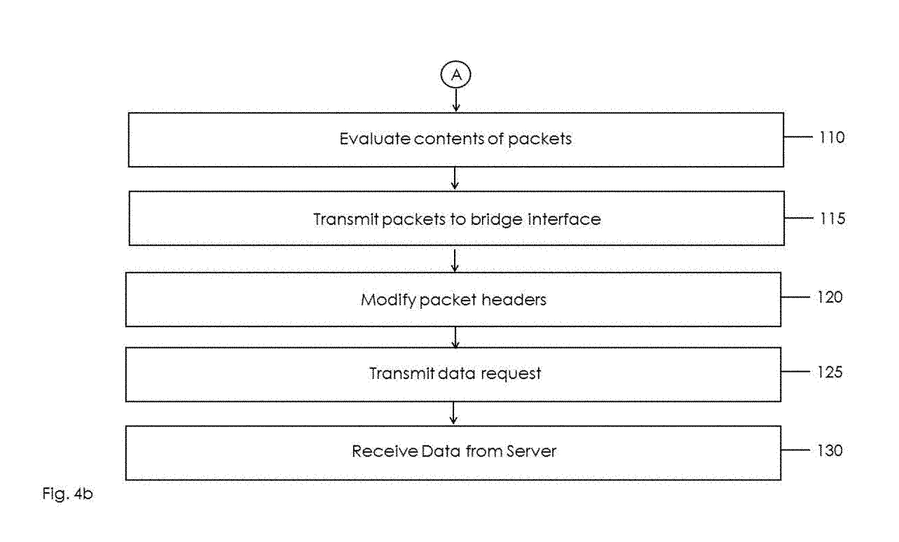

In the example illustrated in FIG. 3, network device 100 is capable of initiating a request for data that is located on a server communicates via the Internet. In an exemplary embodiment, such a server may be located somewhere on the internet. Thus, network device 100 is capable of initiating a request for data over the Internet without router 800 initiating that request. Network device 100 does not have its own public IP address, and therefore uses the public IP address of router 800 in order to request data. In this process (called “piggybacking”), network device 100 is able to identify the public IP address of router 800 because the public IP address of router 800 is located in the header of a packet that is transmitted from router 800 to network device 100, and vice versa. Network device 100 can examine the packet header of the packet received from router 800 to identify the public IP address of router 800 and can then use the identified public IP address as its own public IP address, in order to make the data request and receive data. This process of identifying the IP address of router 800, using the IP address of router 800 as an IP address for network device 100 in order to make a data request, and subsequently receiving the data that was requested by network device 100 is illustrated in FIG. 4a and FIG. 4b. FIG. 4a is a flow chart diagram that explains how network device 100 receives the public IP address of router 800 and FIG. 4b is a flow chart diagram that explains how network device 100 uses the public IP address obtained in FIG. 4a in order to make a data request.

Network device 100 is a bridge device, and is thus a layer 2 device. Because network device 100 is below the network layer, network device 100 is not given a public IP address. Therefore, network device 100 “borrows” the public IP address assigned to router 800 in order to communicate with the internet.

Referring to FIG. 4a, (and with reference to FIG. 3) at step 101, bridge interface is assigned a private IP address (within the range of addresses available for private IP addresses). This allows network device 100 to communicate with other devices. At step 102, a default gateway is configured for bridge interface 500. In this manner, a virtual network is implemented. At step 103, a default route is added that enables packets originating from the TCP/IP stack 600 to be routed to the internet using interface 400. Processing continues in FIG. 4b via off page connector A.

Referring to FIG. 4b (and with reference to FIG. 3), at step 110, bridge interface 500 directs network bridging module 300 to evaluate the contents of packets received from router 800 via network interface 200. Network bridging module 300 evaluates the header of packets received from router 800 in order to identify the public IP address and MAC address of router 800. Bridge interface 500 then stores that public IP address and MAC address of router 800 for later use (step 112). At step 115, socket application 700 uses TCPIP stack 600 to transmit packets to bridge interface 500. The purpose of these packets is to request data from the internet. An exemplary data request includes a request for updated threat data that may be used by a firewall. The packets are generated with a header and a payload. Looking at the packets leaving bridge interface 500, the source IP address is the IP address assigned to the network stack from Bridge Interface 500. Furthermore, the MAC address is the MAC address of Bridge Interface 500. Such packets cannot leave network device 100. Therefore, after leaving bridge interface 500, each packet is further processed so that each packet's source IP address and source MAC address is replaced with those of the router. For example, IP tables and EB table rules are applied to the packets coming out of bridge interface so that the source IP address and source MAC address are replaced with those of router 800 (step 120). Thus the packets leaving network device 100 include in their headers the public IP address and MAC address of router 800. The header also includes the destination IP address of the server on the Internet to which the data request is targeted. The payload includes information regarding the data that is being requested. An example of such data is described below. The data request is transmitted to the target server on the Internet (step 125) and when the target server responds with the requested data, the requested data is received by network device 100 (that has effectively “borrowed” the IP address of router 800) at step 130. In an exemplary embodiment of the present invention, the data that is received by network device 100 in response to the data request that is initiated by network device 100 may not be passed on to router 800.

Note there are situations in which packets flow through network device 100, i.e. between router 800 and modem 900 (for example). Such packet flow may be in the normal course of communication between Wi-Fi and LAN devices 850 and cloud servers 999. To accomplish such communication, network interface 200 is assigned a private IP address from a pool (e.g. range) of private IP addresses. Packets transferred from network interface 200 to router 800 include a header with a source IP address that is the source IP address of packets leaving modem 900.

In the above exemplary embodiment, network device 100 has been described as an apparatus that makes requests for data by using the IP address of router 800. In the exemplary embodiment of the present invention, network device 100 is a firewall. Thus, if network device 100 is a firewall, then when network device 100 initiates the request for data from the Internet, the data that is being requested is data that is used by a firewall. This data, and how it may be used by a firewall, will be described below.

When network device 100 is a firewall, packet classifier 305 evaluates packets that are received from Internet service provider 950 via modem 900 in order to determine whether those packets should be forwarded to router 800. The packets that are received by modem 900 with the intent of being transmitted to router 800 may have malicious content Thus, network device 100 may evaluate each of those received packets (by looking at the source IP address of those incoming packets) to determine whether transmission of those packets to router 800 is allowed or prohibited. In particular, packet classifier 305 may evaluate the contents of the header of each packet that is received in order to determine if the packet should be transmitted to router 800. The information that may be evaluated in the header may include network layer metadata such as source IP addresses and destination IP addresses. The examined data may also include transport layer metadata such as TCP and UDP port numbers.

For example, the evaluated packets may be coming from a server that has an IP address that has either been blacklisted or white listed. If packet classifier 305 is in a blacklist mode, packet classifier 305 includes a list of blacklisted source IP addresses. Any packet received from a blacklisted source IP address may be prevented from being transmitted to router 800 (and inbound packets with a source IP address that has not been blacklisted are allowed by default). Alternatively, packet classifier 305 may be in a white list mode, and may include a list of white listed source IP addresses (and inbound packets with a source IP address that has not been white listed are blocked by default). Any packet received from white listed source IP address may be allowed to be transmitted to router 800. The TCP or UDP port numbers in the evaluated packet may also be evaluated. Packets may be allowed or prevented from being transmitted to router 800 depending upon whether a port number is on a list maintained by packet classifier 305, in addition to whether packet classifier 305 is in a blacklist mode or a white list mode.

Thus, in an exemplary embodiment of the present invention, packet classifier 305 may include a list of IP addresses and or port numbers that are allowed to be transmitted to (or prevented from being transmitted to) router 800. From time to time, however, that list may need to be updated. Exemplary updating may occur regularly, for example with a one hour update interval. Accordingly, network device 100 includes update module 605. Update module 605 communicates with an attack threat intelligence feed server that is located on the Internet and that maintains lists of blacklisted (and/or white listed) IP addresses and/or port numbers. That list is then transmitted from the attack threat intelligence feed server to modem 900 and is subsequently received by update module 605. Upon receipt of the updated list, the list is transferred from update module 605 to packet classifier 305 where it is used to evaluate subsequent traffic received from the Internet. Thus, when update module 605 determines that a new blacklist (or white list) is desired, update module communicates with network bridging module 300 in order to initiate the request for the updated list.

It was previously described how network device 100 obtains the IP address of router 800 in order to send request to the Internet for various data. Thus, in this exemplary embodiment, network device 100 obtains the IP address of router 800 so that network device can use that IP address in order to obtain a revised blacklist (or white list) from the attack threat intelligence feed server (not shown). After update module 605 communicates with network bridging module 300, network bridging module 300 under the control of bridge interface 500 creates one or more packets that instruct the attack threat intelligence feed server to provide the updated list to update module 605. Those packets (that request the revised black/white list) are transmitted to modem 900 and include the source IP address that has been copied from router 800. The modem then replaces the source MAC address of those packets with the destination MAC address of the modem. The modem then forwards the request to the threat intelligence feed server. The steps are summarized at step 120 in FIG. 4b. At step 125, the threat intelligence feed server responds to the received packets with an updated threat data list (black list and/or white list). This updated threat data list is sent to network device 100 using the IP address that network device 100 has copied from router 800. At step 130, the threat data list is received by update module 605. Update module 605 then updates the blacklist (or white list) that is used by packet classifier 305 in order to blacklist or white list packets.

FIG. 3 also illustrates notification module 802. Once a packet has been received and blacklisted (or white listed) by network bridging module 300, analytics regarding the event are forwarded to notification module 805. Notification module 805 then forwards that information to visualization and analytics servers via modem 900. Again, when these analytics are transmitted to the visualization and analytics servers, the analytics may be transmitted in packets having a source IP address that has been copied from router 800 and a destination IP address that is the IP address of the threat intelligence feed server.

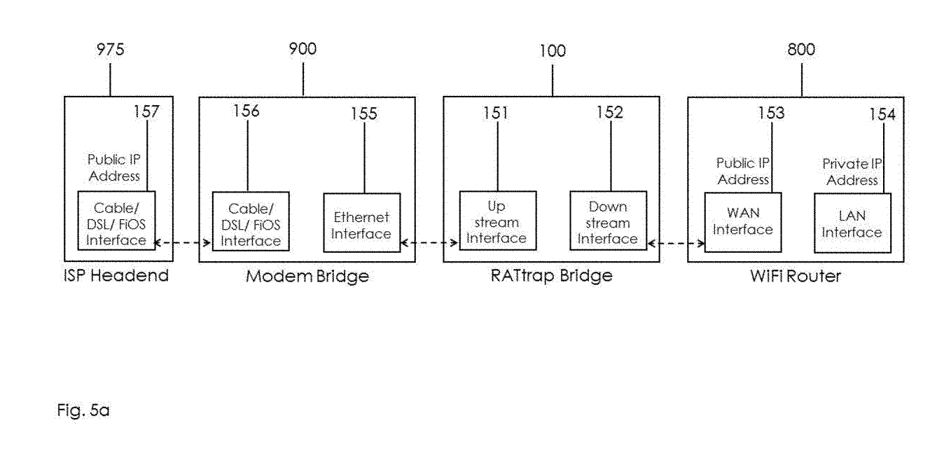

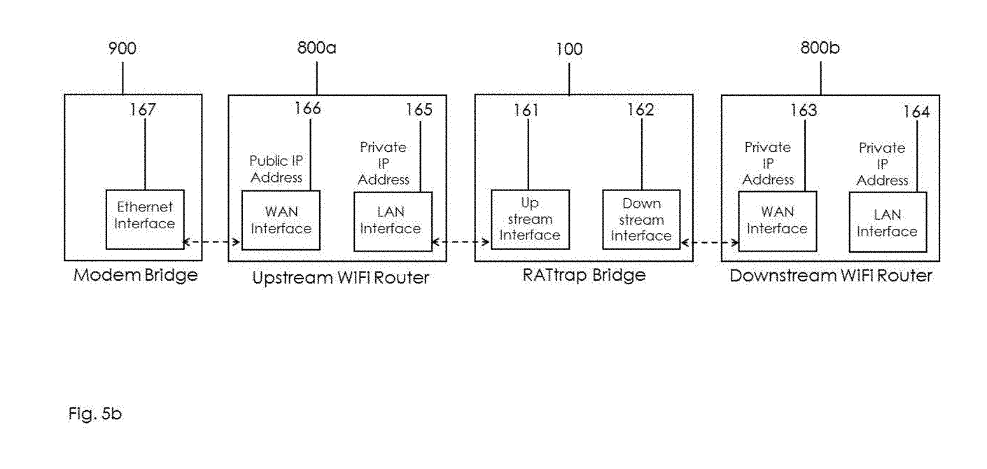

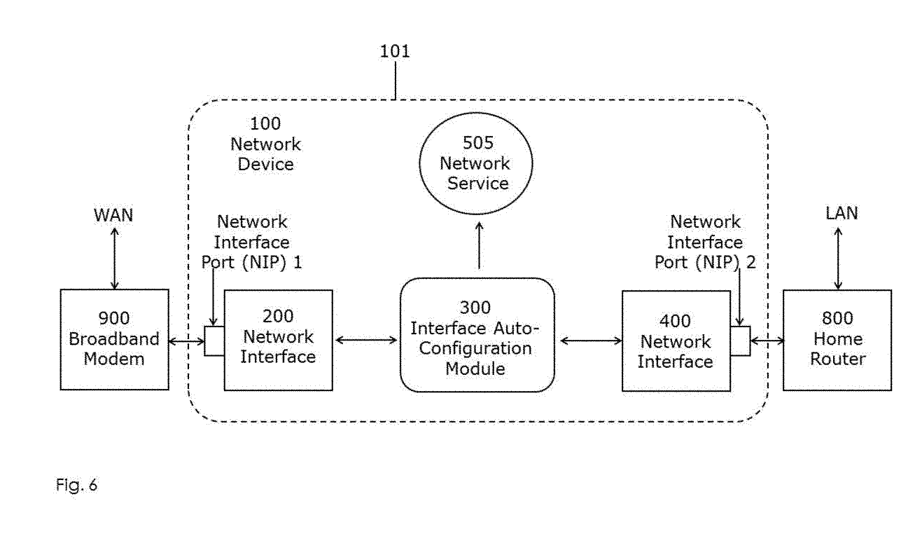

FIG. 5a and FIG. 5b are block diagrams that provide further detail regarding the exemplary configurations that are illustrated in FIG. 1 and FIG. 2, respectively.

In FIG. 5a, network interface device 100 is communicating between router 800 and modem 900. As previously disclosed, in one exemplary embodiment of the present invention, network interface device 100 may be firewall 101. Network interface device 100 includes upstream interface 151 and downstream interface 152. Router 800 may be, for example, a Wi-Fi router. Router 800 includes WAN interface 153 and LAN interface 154. WAN interface 153 is addressable via a public IP address. LAN interface 154 is addressable via a private IP address. WAN interface 153 is capable of communicating with downstream interface 152. Modem 900 is also included. Modem 900 includes Ethernet interface 155 and cable interface 156. While cable interface 156 is illustrated, modem 900 may be communicating via means other than cable interface 156, i.e. DSL, FIOS and satellite. Internet service provider 950 is also included. Internet service provider 950 includes cable interface 157 that is addressable via a public IP address. In this configuration, firewall 101 is capable of stopping malicious traffic that is flowing between router 800 and modem 900, and vice versa.

In FIG. 5b, network interface device 100 is communicating between router 800 A and router 800 B. In the example that is illustrated, router 800 A is an upstream Wi-Fi router while router 800 B is a downstream Wi-Fi router. Network interface device 100 may again be firewall 101. Network interface device 100 includes two interfaces that are previously described as interface 151 and interface 152 illustrated in FIG. 5a, however, the configuration of these interfaces is different. Ethernet interface 161 and Ethernet interface 162 are shown. Network interface device 100 is coupled between router 800 A and router 800 B. In the example that is illustrated, router 800 A is an upstream Wi-Fi router while router 800 B is a downstream Wi-Fi router. Router 800 A includes LAN interface 165 that is accessible via private IP address. Router 800 A also includes WAN interface 166 that is accessible via a public IP address. Router 800 B includes a WAN interface that is accessible via a private IP address. Router 800 B also includes LAN interface 164 that is accessible via a private IP address. Modem 900 is also shown. Modem 900 includes interface 167 that is capable of communicating with WAN interface 166. LAN interface 165 is able to communicate with Ethernet interface 161. Ethernet interface 162 is capable of communicating with WAN interface 163.

The configuration shown in FIG. 5a may be referred to as a WAN mode while the configuration shown in FIG. 5b may be referred to as a LAN mode.

While not shown, network device 100 may alternatively communicate with an ISP via a fiber connection. In such a situation, network device 100 is coupled to a fiber connection via an optical network terminal that includes a fiber interface.

As previously described, network interface device 100 may be located between two other network devices. In one exemplary embodiment, network device 100 is between a modem and a router. In another exemplary embodiment, network device 100 is between two routers. Network device 100 may be situated between other network devices as well.

Network device 100 may be in other locations as well, such as between router and an endpoint (e.g. a PC).

Network devices may include physical ports that enable those devices to be connected with other network devices. With regards to network device 100, network device 100 may include two external ports for connection with the network devices shown in the various figures. FIG. 6 is a block diagram that illustrates network device serving the exemplary function of firewall and connected between router 800 and modem 900. In order to establish the connections that are shown, firewall 101 may include two external ports for connection to router 800 and modem 900, respectively. Firewall 101 is preferably in an enclosure with openings at which two connection ports are situated. In one exemplary embodiment, the two connection ports are female Ethernet connectors. One connector may include a label indicating that it is configured for connection with modem 900 while another connector may include a label indicating that it is configured for connection with router 800.

In a further exemplary embodiment of the present invention, the two connectors that enable firewall 101 to be connected to other network devices may be auto configurable. In other words, a person using firewall 101 may decide which connector is to be connected to modem 900 and which connector is to be connected to router 800 (or put another way, which connector is configured for upstream data and which connector is configured for downstream data). Thus, a user may randomly connect one network device to one of the external connectors on firewall 101 and randomly connect the other network device to the other external connector on firewall 101. In this manner, installation of firewall 101 between a modem and a router is fairly easy, and labeling of the two connectors that enable firewall 101 to be connected to other network devices may be omitted.

In one exemplary embodiment of the present invention, firewall 101 may determine the upstream interface (the interface facing the Internet) and the downstream interface (the interface facing the local network). Once the determination has been made, firewall 101 may use the upstream interface to transmit packets destined for the Internet (originating from a home network, for example) and receive responses from Internet hosts. Once the determination has been made, firewall 101 may also use the downstream interface to receive (and intercept) packets received from the internet as a results of requests originating from a home network, for example. An example of such requests and responses is further described below.

In order to accurately determine the upstream and downstream interfaces, firewall 101 desirably performs the following functions:

1) determine if the firewall is connected between a broadband modem and a router (wan mode) or between 2 routers (LAN mode). In the description that follows this functionality will be referred to as configuration.

2) determine the firewall connector/interface (port) that is connected to the modem and the port that is connected to the router. This functionality will be referred to as orientation.

3) dynamically detect if the configuration or orientation of firewall 101 has changed while firewall 101 is operational I. E. Without going through a reset or power cycle. In one exemplary embodiment of the present invention, a user may leave firewall 101 powered on it may move the device around with in the local network.

4) determine the IP address range of the network into which firewall 101 is set up to configure non-conflicting IP addresses for its internal bridge interface.

Firewall 101 those runs in bridge mode i.e. the two interfaces/connectors (ports) on firewall 101 are not assigned IP addresses. Furthermore, firewall 101 does not modify IP or MAC addresses in packets that pass through firewall 101 (e.g. between router and modem).

An exemplary embodiment in accordance with the above is illustrated in the block diagram of FIG. 6. FIG. 6 shows one possible configuration of network device 100 between router 800 and modem 900. Network interface 200 is coupled to modem 900 via network interface port (NIP) 1. Network interface 400 is coupled to router 800 via network interface port (NIP) 2. While FIG. 6 illustrates modem 900 connected to NIP 1 and router 800 connected to NIP 2, this configuration may be reversed so that router 800 is connected to NIP 1 and modem 900 is connected to NIP 2. In a further exemplary embodiment, the two network interface ports are connected between a router and a LAN device. Auto configuration module 300 is capable of determining information about the devices connected to WIP 1 and WIP 2. Auto configuration module 300 supplies this information to network service module 505. Network service module 505 may use this information in order to initiate IP-based communication to servers on the Internet over the network interface that is connected to the modem. Exemplary IP-based communication includes requesting a threat data update as described above.

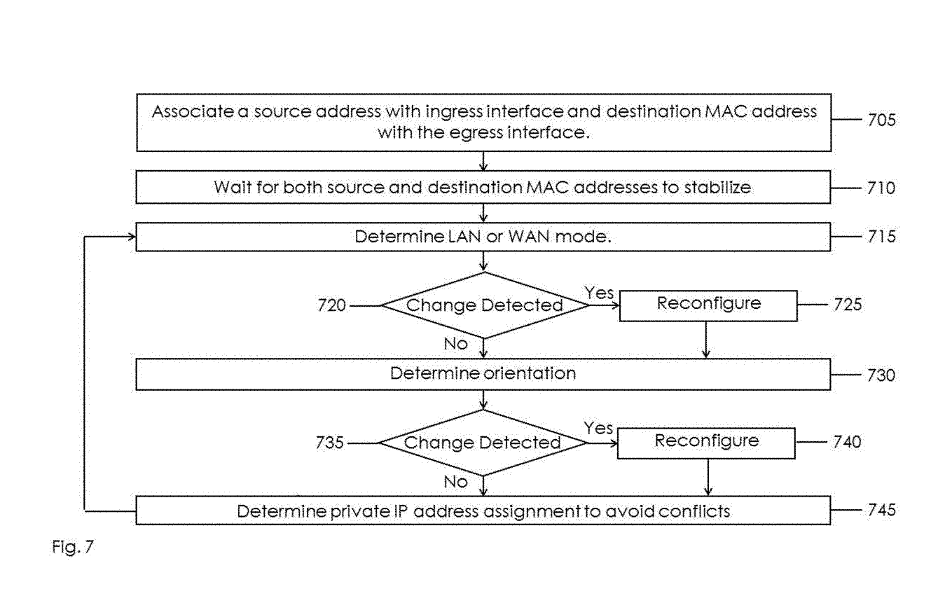

Auto configuration is thus included in an exemplary embodiment of the present invention that is illustrated with the flowchart diagram of FIG. 7. At step 705, firewall 101 associates the source MAC address of an incoming packet with the ingress interface and the destination MAC address of the incoming packet with the egress interface. This enables firewall 101 to detect any changes to the devices that are connected on either one of its ports. Once the MAC address associated with either interface remain static over a certain number of packets (step 710), the orientation and/or configuration detection logic will be triggered.

Configuration, or the determination of whether firewall 101 is in WAN mode or LAN mode occurs at step 715. If at step 720, a change in packets being received at either interface is detected, then processing proceeds to step 725 so that the interfaces can be reconfigured. At step 730, orientation is determined. At step 735, if a change in orientation is detected, reconfiguration occurs at step 740. At step 745, steps are taken to avoid IP address conflicts. Processing and proceeds back to step 715.

In order to implement the aforementioned functionality, firewall 101 continuously captures packet metadata (headers) from packets flowing from one interface to the other. This metadata includes, but is not limited to source MAC address, destination MAC address, layer 3 protocol, source IP address, destination IP address, and the ingress and egress interfaces of the packet. This captured packet metadata may be used to configure network interface 200 and network interface 400 as further described below.

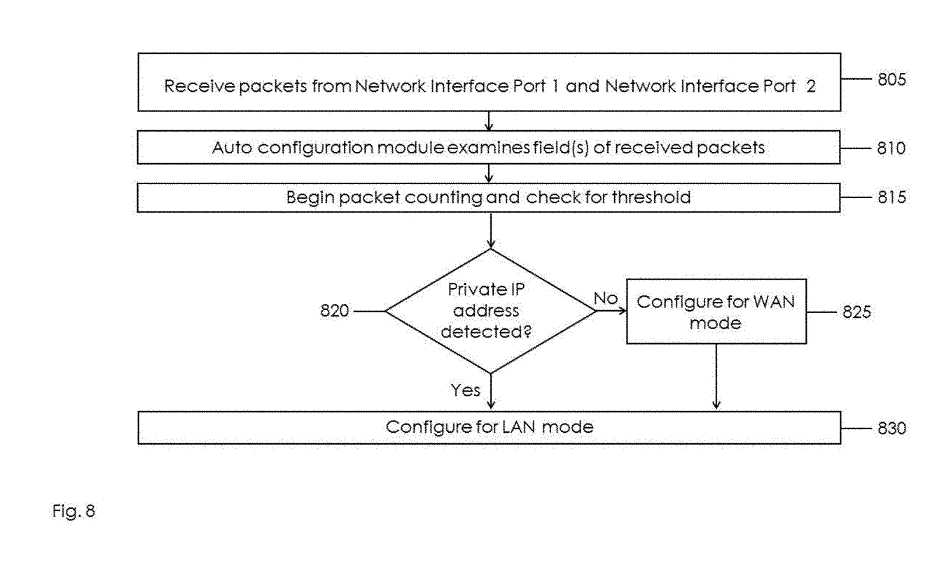

FIG. 8 is a flowchart diagram that illustrates how firewall 101 is able to determine whether it is in a WAN mode or a LAN mode. In order to make this determination, auto configuration module 300 performs the analysis of the source IP address field or the destination IP address field (or both) of each received packet. Using IPv4 as an example, there are address ranges in IPv4 that are reserved for private IP addresses. Those address ranges are known to one of ordinary skill me art. As those are private IP addresses, they are considered to be non-routable. By contrast, most other IPv4 addresses are considered to be routable or public addresses.

At step 805, firewall 101 receives packets from NIP 1 and/or NIP 2. At step 810, auto configuration module 300 examines the IP address fields in the header of received packets. At step 815, an optional timing threshold step begins. In this optional step, IP address fields are examined for a predetermined period of time. As an alternative to this optional step, a limited number of packet headers are evaluated. At step 820, a determination is made as to whether a private IP address has been detected in the packet. For example, firewall 101 may classify a packet as a LAN packet when the packet contains a private IP address in either the source from the destination IP address fields of the packet. If a private IP address is identified, then it is concluded that firewall 101 is connected to a network that uses private IP addresses. This would imply that firewall 101 is in a LAN mode configuration. In an exemplary embodiment of the present invention, to eliminate false positives (when packets of private IP addresses occasionally show up in public networks), a sliding window algorithm may be used. This algorithm is in accordance with optional step 815. When the observed number of private IP addresses exceeds a threshold, it is concluded that firewall 101 is in a LAN configuration. If the window expires without a minimal number of private IP addresses having been identified, it is determined that firewall 101 is in a WAN configuration. Accordingly, at step 825 if private IP addresses are not detected (or less than a threshold are detected), firewall 101 is configured for WAN mode. Alternatively, if a threshold number of private IP addresses are detected, then firewall 101 is configured for LAN mode.

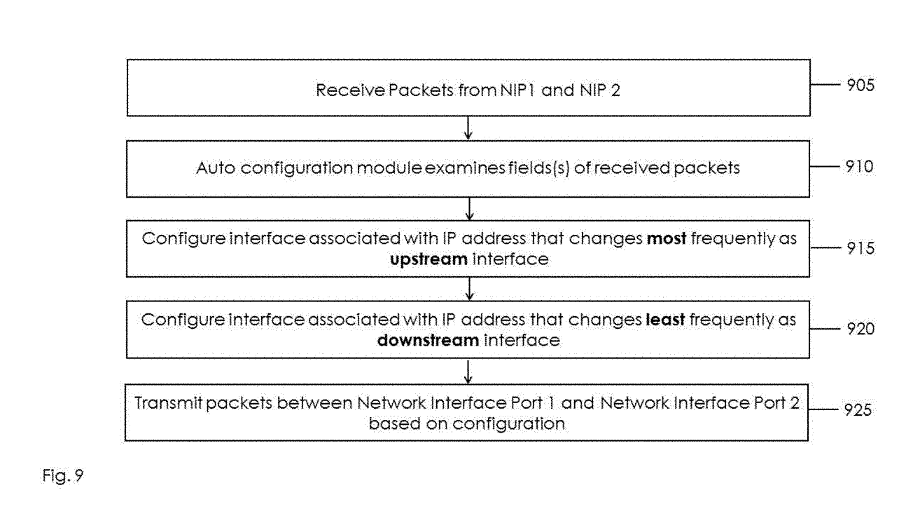

FIG. 9 is a flowchart diagram that illustrates configuration of network interface 200 and network interface 400 based on the network device that is directly connected to each network interface. At step 905, packets are received from NIP 1 and/or NIP 2. At step 910, auto configuration module 300 examines fields within the received packets. At step 915, the network interface associated with the IP address that changes most frequently is configured as the upstream interface. For example, when packets are flowing from a router to a modem, the source IP address will typically remain the same because the packets are coming from a single network. At the same time, looking at those packets, the destination IP address will be constantly changing as the router is sending packets to the modem in order to retrieve data from various servers on the Internet. As a result, the destination IP address will be frequently fluctuating. Thus, when a network device is communicating directly with the network interface and the source IP address is constant while the destination IP address is changing, the packets are being transmitted from the local network side of the firewall. Alternatively, packets received by a modem, and destined for a router will have source IP addresses that are constantly changing at a destination IP address that is constant. The interface receiving such packets is on the Internet facing side of firewall 101. Thus, at step 915, the interface associated with IP addresses that changes most frequently is configured as the upstream interface. At step 920, the interface associated with the IP addresses that changes least frequently are configured as the downstream interface. Alternatively, the interface associated with an IP address that does not change is configured as the downstream interface. Firewall 101 then transfers packets between NIP 1 and NIP 2 based on the configuration established at step 915 at step 920.

Again, once firewall 101 has configured these interfaces, update module 605 (see FIG. 3) is able to request threat data files. The update module can communicate with network interface 200 are network interface 400 in order to initiate a request for a current threat data file to be received based on the determination set forth above as to which network device is attached to which network interface.

Thus, the usability and configuration of network device 100 is improved by allowing user to connect any of the two interfaces of the device to a modem and the other interface to a router. This removes the need for providing any markings on the network device, which would otherwise be required, to guide the user to connect the network device to the modem and router with the correct orientation.

Also, in accordance with the above, the user is able to swap the interfaces to which the modem and the router are connected to the network device while the device is powered on and running.

The above steps, structure, and features enable significant advantages over the prior art. It is noted that network device 100 is situated between two network interfaces. In the example, the network interfaces are router 800 and modem 900. It is understood, however, that the network interfaces may be other types of network interfaces. For example, network device 100 may be in a bridge environment between 2 routers.

The above concept enables significant simplicity in the installation of a firewall (for example) over the prior art. For example, network device 100 (I. E. Firewall) may include two visible Ethernet ports on an exterior thereof. One Ethernet port may be used to connect and Ethernet cable from that Ethernet port to the WAN side of the router. The other Ethernet port may be used to connect and other Ethernet cable from that port to the land side of the modem. Therefore, by connecting the firewall between the router in the modem in the example illustrated above, a firewall can be placed between a router and a modem. Furthermore, in one exemplary embodiment, no reconfiguration of the router is required. Network device 100 acting as a firewall is obtaining the IP address of router 800 simply by scanning normal traffic that is transmitted from router 800 with the destination of modem 900. Furthermore, as the decision to block or allow IP addresses reports is being made within network device 100, and because network device 100 itself is doing the blocking or allowing of packets based on the evaluation, no reconfiguration of router 800 is required as router 800 is not playing a role in the packet blacklisting or white listing that is occurring in network device 100.

The inventors of the present invention do not wish to imply that in the above configuration, disabling of the firewall that normally resides within router 800 is required. In a preferred embodiment of the present invention, the firewall which is normally found within router 800 continues to perform a firewall function, but the choice as to whether this is to be performed may be left to the discretion of the router user.

Thus, a network device is able to prevent malicious traffic from entering a home network and malicious traffic originating from a potentially compromise that work may be prevented from reaching its intended destination.

In a further exemplary embodiment of the present invention, network packets are intercepted based on application layer information included with those packets. Service request network packets are received from a client on one network interface, and the requests are proxied over a secure channel to a secure server. Since the communication channel between the network device and the internet server is secure, it provides the client complete security and privacy for such service requests.

An exemplary embodiment relates to DNS requests. When a router (based on a request from a web browser running on a PC, for example) transmits a DNS request to an ISP, the ISP's DNS server resolves the request by returning to the router the IP address associated with the requested URL.

In an exemplary embodiment of the present invention, each DNS request (i.e. each request going to the DNS port—port 53) is intercepted after leaving the router. The DNS request is then encrypted, forwarded to a DNS server (potentially other than the DNS server used by the ISP), looks at the domain, confirms from a blacklist (or whitelist) that the domain is not malicious, optionally confirms whether the domain should be blocked from a parental perspective, resolves the domain to an IP address, and then returns the encrypted response back to the location where the DNS request was previously intercepted. The response is decrypted, converted into a port 53 response, and is then sent back to the router which sends it back to the web browser (on the PC).

In this manner, the end user is given complete privacy over what domain the user desires to visit by hiding that information from the ISP (or whomever else is in the DNS resolution path). Two objectives are thus achieved: 1) DNS domain based protection is provided to protect the user from visiting a website which is a malicious domain; and 2) Prevent the ISP from seeing what domain is desired to be visited.

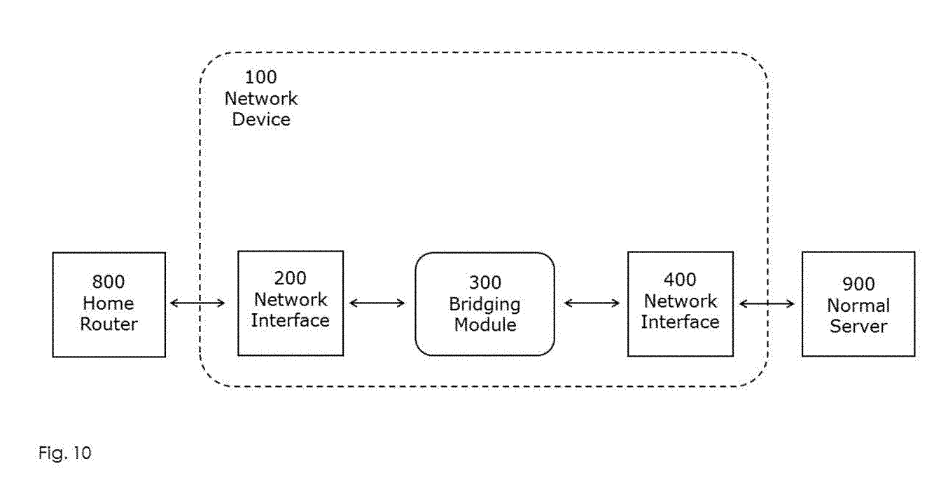

FIG. 10 illustrates the flow of requests from a home internet router through the network device to a server on the internet. Similarly, it shows responses from the server flowing through the network device, back to the home internet router. An example of such a request and response transaction is Domain Name System (DNS). This is the normal operation of a network device without engaging the invention described in this document

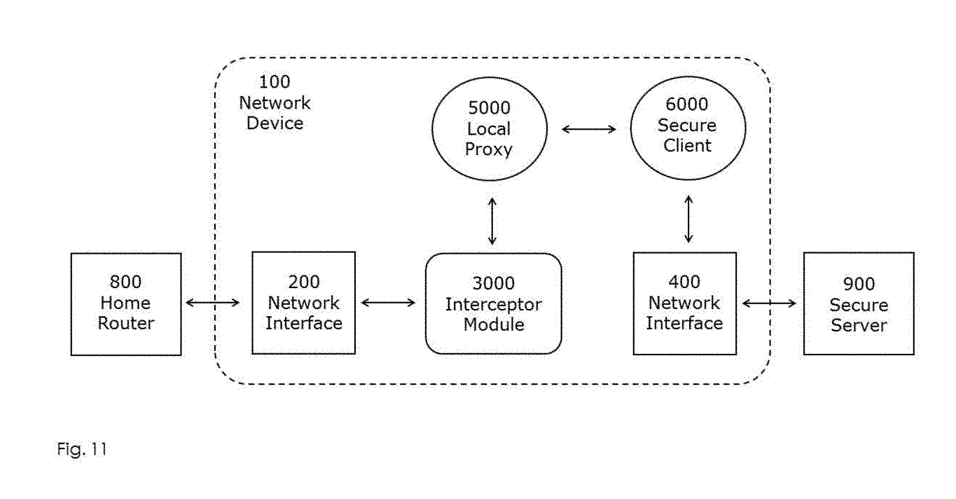

FIG. 11 illustrates the flow of requests and responses between the home internet router and a secure server through the network device when secure service proxy feature is engaged.

The following description refers to FIG. 11.

The home router 800 generates a service request on a certain transport layer port number that flows into the network device 100 through the network interface 200. An example of such a request is DNS request that uses User Datagram Protocol (UDP) port 53.

The request is intercepted by the interceptor module 300 which looks of requests on certain predetermined set of transport layer protocols and ports. Upon receiving such a request, it does not forward it to the network interface 400, instead it forwards to a local proxy service 5000 running on the network device 100.

The local proxy 5000 performs a cache lookup to check if the request can be responded to directly from information available on the network device 100. In the event that the information is not available, the local proxy forwards the request to the secure client 6000 which encrypts the request and sends it through the network interface 400 over the internet to the secure server 900.

On the return path the encrypted response sent back by the secure server 900 is received by the secure client 6000 which decrypts and forwards it to the local proxy 5000 which in turn gives it to the interceptor module 300 to send it back to the home internet router 800. The interceptor module uses a network connection tracker to match the response back to a prior request.

The benefit of this exemplary embodiment is that any intermediary devices present between the network device 100 and the secure server 900 are unable to examine the contents of requests and responses. This provides complete security and privacy for the requests and responses exchanged between the network device and the secure server.

A network device comprises a network interface for receiving, from a source, a request for a first server at a first network address to respond; an interceptor module for preventing the request from being forwarded to the first network address and treating the request as a secure request if the request includes one of a predetermined set of transport layer protocols and ports; and a secure client that encrypts the secure request and transmits the secure request to a second server having a second network address different than the first network address. A network device may further comprise a local proxy that performs a cache lookup of the request to determine if said network device can respond to said request without transmitting the secure request to the second server. A network device may further (or alternatively) include said network device receiving a secure response to the secure request, the secure client decrypting the secure response to obtain a decrypted response, and the decrypted response transmitted to the source.

In a further exemplary embodiment of the present invention, data feeds are collected and automated analyses are performed. This exemplary embodiment may be useful, for example, in an environment in which a network (or a computer) is communicating with the internet, because there is potential for the network to be subject to malicious attack.

In general, it is desirable to protect internet connected devices from malicious behavior. As is known in the art, a home router with wireless access point functionality may be used to couple multiple deices to a private network, so that each device may be capable of accessing the internet through the home router. All such devices are susceptible to being attacked from the internet as well as from within a potentially compromised private network. One known method of protecting such devices is through the use of a port blocking firewall running on a home router. Other methods for addressing threats to a user's privacy and security are desirable.

One method of providing improved privacy and security is accomplished with an exemplary embodiment of the present invention that relates to a backend system (on the internet, for example) that receives threat intelligence data fees from multiple sources. The data from these sources is downloaded, subjected to de-confliction rules, normalized, aggregated, and processed to obtain a comprehensive threat intelligence list that can downloaded by multiple clients (network devices) and may be used to identify and block malicious network traffic. The comprehensive list is may include risk/confidence scores that are calculated for destination IP addresses on the list. The list that is downloaded by multiple clients may be truncated and/or compressed for more efficient (and potentially size constrained) delivery.

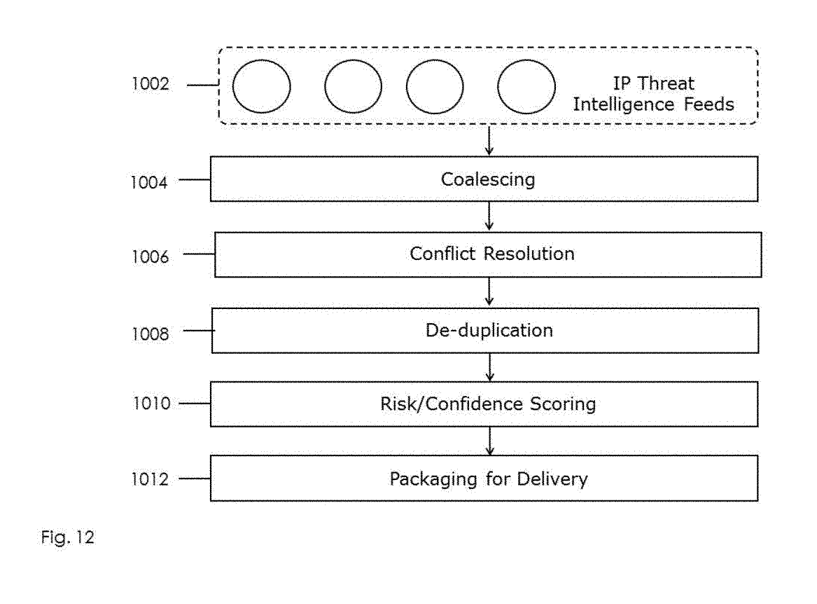

Operation of an exemplary embodiment of the present invention is illustrated in the flow chart diagram that appear in FIG. 12.

At step 1002, threat intelligence data is obtained from multiple services that may include different commercial and/or non-commercial vendors. The data is obtained from multiple IP threat intelligence feeds that provide the threat intelligence data in different forms (i.e. different formats). These services may be public, open source, commercial or proprietary sensor networks, for example. These feeds are accessible via web (HTTP/HTTPS) based application programming interfaces (APIs). Each feed is downloaded by using the HTTP/HTTPS based API by a cloud based service, and may be downloaded on specific update intervals defined for each individual feed.

At step 1004, after the data has been downloaded, the data is normalized in a form that can be processed by the backend and coalesced into a single data store. Normalizing may be accomplished through various templates, with a template that is available for each respective IP threat intelligence feed. The templates convert the data in fields and formats associated with each IP threat intelligence feed into a common format.

Different feeds from different sources could potentially classify the same IP addresses or IP address ranges with conflicting attributes. At step 1006, these conflicts are resolved. For example, if one feed classifies a certain (or multiple) IP address or range as being safe, and another feed classifies that certain (or multiple) IP address or range as harmful, the address or range is classified as harmful. This also includes the removal of false positives (those feeds that erroneously identify as harmful but which have previously and consistently identified as safe) through a master exclusion database.

The IP address data is then processed to remove any duplicate entries to eliminate redundancy and optimize the size of the data. This occurs at step 1008.

Multiple factors may then be used to assign a malicious risk and confidence score to each IP address or IP address range (step 1010). In one exemplary embodiment, the score that is assigned at step 1010 is merely forwarded from a third party. In another exemplary embodiment, the score is obtained using several exemplary processes. For example, the score for an IP address may be affected, by that IP address being the source of scanning of multiple ports on another IP address. Or, the score may be affected by the detection, from multiple physical locations, of a single IP address being the source of scanning a common range of IP addresses. Or, if a single IP address has been identified as a source of malicious traffic, as the frequency of traffic from the IP address increases, its score may increase. Another technique may be to determine if a URL has been registered for an IP address originating suspected malicious traffic. Registration (or lack thereof) may affect the score. As a further example, traffic intentionally sent to an IP address may indicate that the IP address is not a source of malicious traffic—which would again influence score. These illustrations are merely examples.

Finally, at step 1012, the IP address(es) and/or IP address range(s) are packaged in a format that can be efficiently downloaded by devices deployed at customer premises over the internet. This may include truncation and/or compression.

In accordance with the above, a (home) user may be benefited user by making their internet browsing safer and protecting the devices connected to the (home) network by blocking malicious traffic based on a single comprehensive threat intelligence list assembled from multiple disparate threat intelligence sources.

A method of performing IP address classification, comprises the steps of receiving threat intelligence data fees from a plurality of different sources, normalizing each received intelligence data feed; resolving conflicts between IP addresses or IP address ranges in ones of said feeds; removing duplication among said IP addresses or IP address ranges in said feeds; assigning a risk and confidence score to each of said IP addresses or IP address ranges; packaging said IP addresses or IP address ranges along with each respective risk and confidence score to obtain packaged data; transmitting said packaged data to a source via internet communication. Optionally, the feeds are received via web based application programming interfaces.

In an exemplary embodiment of the present invention a computer system may be included and/or operated within which a set of instructions, for causing the machine to perform any one or more of the methodologies discussed herein, may be executed. In alternative embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a personal digital assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system includes a processing device, a main memory (e.g., read-only memory (ROM), flash memory, dynamic random access memory (DRAM) (such as synchronous DRAM (SDRAM) or Rambus DRAM (RDRAM), etc.), a static memory (e.g., flash memory, static random access memory (SRAM), etc.), and a data storage device, which communicate with each other via a bus.

Processing device represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device may also be one or more special-purpose processing devices such as an application specific integrated circuit (ASIC), a field programmable gate array (FPGA), a digital signal processor (DSP), network processor, or the like. Processing device is configured to execute listings manager logic for performing the operations and steps discussed herein.

Computer system may further include a network interface device. Computer system also may include a video display unit (e.g., a liquid crystal display (LCD) or a cathode ray tube (CRT)), an alphanumeric input device (e.g., a keyboard), a cursor control device (e.g., a mouse), and a signal generation device (e.g., a speaker).

Data storage device may include a machine-readable storage medium (or more specifically a computer-readable storage medium) having one or more sets of instructions (e.g., reference generation module) embodying any one or more of the methodologies of functions described herein. The reference generation module may also reside, completely or at least partially, within main memory and/or within processing device during execution thereof by computer system; main memory and processing device also constituting machine-readable storage media. The reference generation module may further be transmitted or received over a network via network interface device.

Machine-readable storage medium may also be used to store the device queue manager logic persistently. While a non-transitory machine-readable storage medium is shown in an exemplary embodiment to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instruction for execution by the machine and that causes the machine to perform any one or more of the methodologies of the present invention. The term “machine-readable storage medium” shall accordingly be taken to include, but not be limited to, solid-state memories, and optical and magnetic media.

The components and other features described herein can be implemented as discrete hardware components or integrated in the functionality of hardware components such as ASICs, FPGAs, DSPs or similar devices. In addition, these components can be implemented as firmware or functional circuitry within hardware devices. Further, these components can be implemented in any combination of hardware devices and software components.

Some portions of the detailed descriptions are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the aforementioned description, numerous details are set forth. It will be apparent, however, to one skilled in the art, that the disclosure may be practiced without these specific details. In some instances, well-known structures and devices are shown in block diagram form, rather than in detail, in order to avoid obscuring the disclosure.

The disclosure is related to an apparatus for performing the operations herein. This apparatus may be specially constructed for the required purposes or it may comprise a general purpose computing device selectively activated or reconfigured by a computer program stored therein. Such a computer program may be stored in a non-transitory computer readable storage medium, such as, but not limited to, any type of disk including floppy disks, optical disks, CD-ROMs and magnetic-optical disks, read-only memories (ROMs), random access memories (RAMs), EPROMs, EEPROMs, magnetic or optical cards, flash memory devices including universal serial bus (USB) storage devices (e.g., USB key devices) or any type of media suitable for storing electronic instructions, each of which may be coupled to a computer system bus.

Whereas many alterations and modifications of the disclosure will no doubt become apparent to a person of ordinary skill in the art after having read the foregoing description, it is to be understood that any particular implementation shown and described by way of illustration is in no way intended to be considered limiting. Therefore, references to details of various implementations are not intended to limit the scope of the claims, which in themselves recite only those features regarded as the disclosure.

It is claimed:

1. A firewall for selectively allowing or blocking traffic between a first network interface and a second network interface, said firewall comprising:
a packet classifier that evaluates said traffic between said first network interface and said second network interface and allows or blocks said traffic based on content of classifier data accessible by said packet classifier;
an IP address identifier for identifying an IP address of said second network interface; and
a classifier data updater for initiating a request for said classifier data to be updated, and for receiving an update to said classifier data responsive thereto, wherein said request is transmitted from said updater to said first network interface, said update is received from said first network interface, and said request identifies said firewall as destination of said update with said IP address of said second network interface identified by said IP address identifier.

2. A firewall according to claim 1, further comprising:
a. a first port for coupling said firewall to said first network interface; and
b. a second port for coupling said firewall to said second network interface.

3. A firewall according to claim 2, wherein said traffic which is allowed or not blocked is permitted to be received by said first port from said first network interface, and is then transmitted from said second port towards said second network interface.

4. A firewall according to claim 1, wherein said traffic received from said first network interface is received from a modem, and wherein said traffic transmitted to said second network interface is transmitted to a router.

5. A firewall according to claim 1, wherein said request is included with traffic transmitted from said firewall to said first network interface and said update is included with traffic transmitted from said first network interface to said router.

6. A firewall according to claim 1, wherein said classifier data updater requests said update without said second network interface requesting said update.

7. A method for selectively allowing or blocking traffic between a first network interface and a second network interface, said method comprising the steps of:
evaluating said traffic between said first network interface and said second network interface and allowing or blocking said traffic based on content of classifier data;
identifying an IP address of said second network interface; and
initiating a request from between said first network interface and said second network interface for said classifier data to be updated, and for receiving an update to said classifier data responsive thereto, wherein said request is transmitted to said first network interface, said update is received from said first network interface, and said request identifies said source of said request as destination of said update with said IP address of said second network interface identified by said IP address identifier.

8. A method according to claim 7, wherein said request is initiated from a firewall, and wherein:
a. a first port couples said firewall to said first network interface; and
b. a second port couples said firewall to said second network interface.

9. A method according to claim 8, wherein said traffic which is allowed or not blocked is permitted to be received by said first port from said first network interface, and is then transmitted from said second port towards said second network interface.

10. A method according to claim 7, wherein said traffic received from said first network interface is received from a modem, and wherein said traffic transmitted to said second network interface is transmitted to a router.

11. A method according to claim 8, wherein said request is included with traffic transmitted from said firewall to said first network interface and said update is included with traffic transmitted from said first network interface to said router.

12. A method according to claim 7, wherein said update is requested without said second network interface requesting said update.
